(19) United States
(12) Patent Application Publication
(10) Pub. No.: US 2022/0330523 A1
(43) Pub. Date: Oct. 20, 2022

(54) DOG GROOMING TOOL

(71) Applicant: Nelson C. BEGEOT, JR., Newton Falls, OH (US)

(72) Inventor: Nelson C. BEGEOT, JR., Newton Falls, OH (US)

(21) Appl. No.: 17/720,661

(22) Filed: Apr. 14, 2022

Related U.S. Application Data
(60) Provisional application No. 63/175,231, filed on Apr. 15, 2021.

(51) Int. Cl. A01K 13/00

(52) U.S. Cl. CPC A01K 13/00

(57) ABSTRACT

An animal grooming tool includes an elongated handle portion having a first tapered end for precise removal of hair and a second opposite concave/curved portion with a surface substantially complementary in shape to a human thumb. Each of the first and second ends are coated with a texture/grit enhancing coating. The ergonomically shaped tool, facilities removal of hair from and animal for grooming and increased comfort to the user.

This application claims priority benefit of U.S. Provisional Patent Application Ser. No. 63/175,231 filed Apr. 15, 2021, entitled “Dog Grooming Tool,” the complete disclosure of which, in its entirety is herein incorporated by reference.

### BACKGROUND

The present disclosure relates to animal grooming tools and methods for grooming an animal. The grooming tools have particular application in conjunction with stripping the coat of an animal and will be described with particular reference thereto. However, it is to be appreciated that the present disclosure is also amenable to other like applications.

Stripping or hand-stripping is the process of pulling the dead hair out of the coat of canine/dog, either by using a stripping knife or the fingers. A hard, wiry coat of a dog has a cycle where it starts growing and then sheds as it reaches a maximum length. Hand-stripping coordinates the shedding and makes room for a new coat to grow. Stripping is the proper grooming method for most terriers, spaniels, and many other dog breeds. The hair is removed with either a stripping knife or stripping stone. This allows for a new and more vibrant protective coat to grow in.

Current tools used for stripping the coat of a dog are generally flat, much like a butter knife. Some of the current tools with abrasive properties are prone to breaking, e.g., those made of compressed grit or stone.

Described herein are improvements to current dog grooming tools, including the use of a tool having at least one curved end which provides comfort to the user and is more efficient at gripping clusters of dog hair during stripping.

### SUMMARY

In accordance with the present disclosure an exemplary grooming tool for an animal is described. The grooming tool includes a central elongated handle portion with a first end and a second end. The first end includes a tapered portion that decreases in thickness away from the handle portion. The second end includes a concave/curved portion that has a top surface that includes a contour substantially complementary to that of a human thumb. In some embodiments, the second end decreases in thickness from the handle portion.

Each of the first end and second end are coated with a textured coating that facilitates grip and hair capture properties of the tool.

In accordance with other aspects of the current disclosure, an animal grooming tool includes an elongated handle, a thumb receiving portion located about a first end of the elongated handle, the thumb receiving portion having a concave curvature in at least one direction, and a texture coating on the thumb portion. In a further embodiment, the animal grooming tool further comprising a second end having a taper portion. In another further embodiment, the taper portion is coated with a texture coating. In another further embodiment, the elongated handle tapers along the concave portion. In another further embodiment, the taper of the concave portion terminates at a point. In another further embodiment, the grooming tool comprises a metal. In another further embodiment, the grooming tool comprises one of aluminum and steel. In another further embodiment, the concave curvature of the thumb portion is curved in two directions. In another further embodiment, the body includes a top surface and a bottom surface, wherein the bottom surface and top surface are angled along a portion of the second end to form a point, and wherein the top surface of the thumb portion includes a concave surface. In another further embodiment, the thumb portion includes a second concave surface along the bottom surface of the body. In another further embodiment, the texture coating is silicon carbide thermomechanical bonded to an entire surface area of the thumb portion. In another further embodiment, the texture coating is a polymer based epoxy including silicon carbide particles. In another further embodiment, the texture coating has a grit of about 60-90. In another further embodiment, the body has a substantially rectangular cross-section. In another further embodiment, a length of a tool is about three to about eight inches.

In accordance with another aspect of the disclosure, a method for grooming and animal, such as a dog is disclosed. The method includes providing a grooming tool having an elongated handle and a thumb receiving portion located about a first end of the elongated handle, the thumb receiving portion having a concave curvature in at least one direction. The method also includes positioning the first end of the handle proximate the body of an animal and capturing a plurality of hairs of the animal by pressing a portion of a user's hand against the thumb receiving portion of the grooming tool. While maintaining pressure against the thumb receiving portion, pulling the grooming tool away from the body on the animal, removing hair.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates side views of several exemplary embodiments of animal grooming tools in accordance with the present disclosure.

FIG. 2 illustrates a side perspective view of an exemplary grooming tool in accordance with the present disclosure.

FIGS. 3-6 illustrate use of exemplary grooming tool used on an animal to remove hair from an animal.

FIG. 7 illustrates a side view of another exemplary grooming tool in accordance with the present disclosure.

### DETAILED DESCRIPTION

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

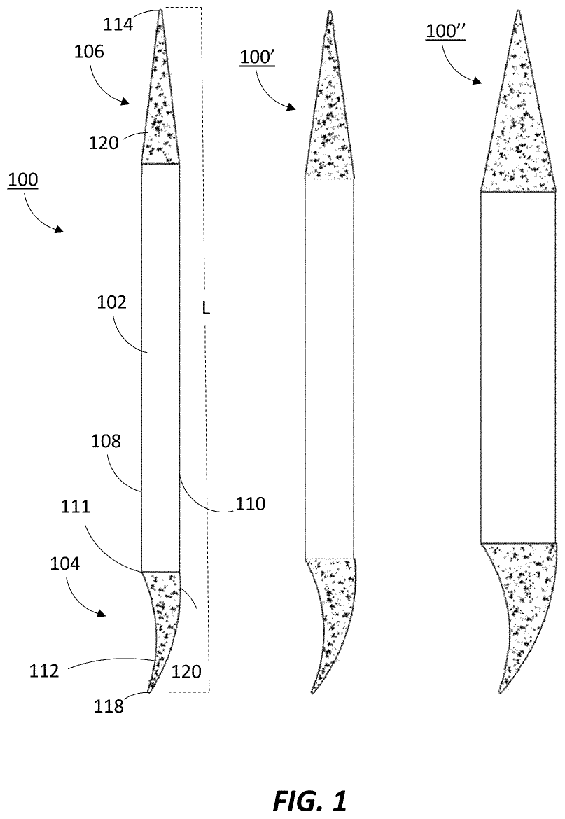

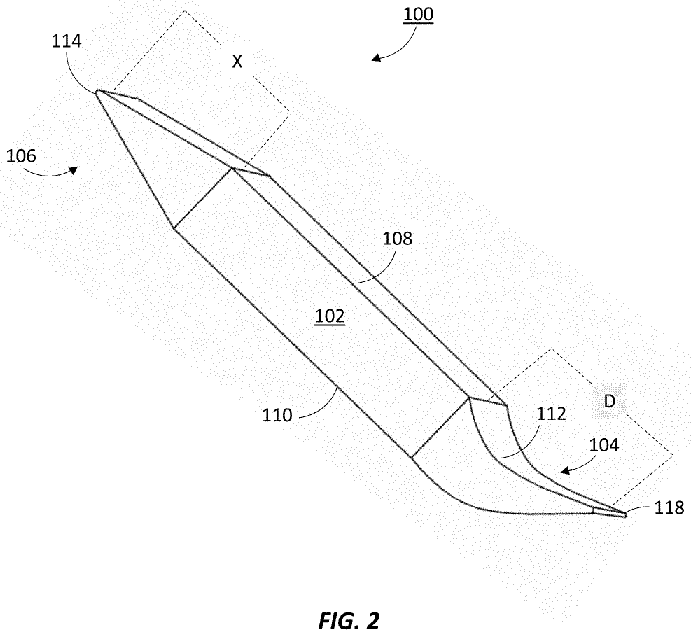

With reference to FIGS. 1 and 2, shown are exemplary grooming tools 100, 100′, and 100″ for stripping the hair of an animal. The grooming tools 100, 100′, 100″, while shown having different sizes include a pointed end and a curved end. It is to be appreciated that the features of each tool 100, 100′, 100″, may generally be described by reference to grooming tool 100. Grooming tool 100 includes a substantially elongated body 102 having a first end 104 and a spaced apart second end 106, the body 102 sized and configured to be held by a human hand. In some embodiments and as illustrated in FIG. 2, the body has a substantially rectangular profile having a substantially square/rectangular cross-section. However, it is to be appreciated that the cross-section of the tool is not limiting and that the tool may have any cross-section. For example, the body of a grooming tool may be cylindrical, prism-like, etc.

The grooming tool 100 may have a length L from about 3 inches to about 8 inches, including about four (4) inches to about six (6) inches. In some embodiments, the length L of the grooming tool is custom fabricated to suit a particular user's hand and comfort. That is, users with larger size hands may prefer a longer tool, i.e., a tool from about 5-8 inches in length. Likewise, users with smaller hands may prefer a shorter tool. In the substantially rectangular embodiment of FIG. 1, the grooming tool 100 has a body 102 with a substantially planar and parallel top surface 108 and bottom surface 110.

As illustrated in FIGS. 1 and 2, the first end 104 of the grooming tool 100 is tapered and curved to form a concave surface 112 wherein the concave surface 112 is generally configured to conform to a thumb of a user. When using the grooming tool 100, the user holds the central portion of the tool body 102 between his/her fingers and palms with the thumb resting within the top concave surface 112. The first end 104 of the grooming tool 100 is placed near a patch of hair to be removed (i.e., “stripped”) from an animal. The thumb is then pressed against the top concave surface 112 to sandwich the hair of an animal there between allowing the user of the grooming tool 100 to then pull and strip the captured hair off the animal. The ergonomic design of the concave surface “scoop” and increased surface area (as compared to conventional flat tools) provides for easy manipulation of target hairs for animal grooming.

In some embodiments and with particular reference to FIG. 2, the concave curvature of the concave surface 112 is in a single direction along the long axis of the tool. In other embodiments and not illustrated, the concave curvature of the concave surface 112 is curved in two directions, along the long axis of the tool and along an axis perpendicular thereto. In the embodiment with curvature in two directions, the concave portion is analogous to the shape of a spoon. In some embodiments, the radius of curvature is about two (2) inches however; the curvature of the concave portion is best described as consistent with curvature of the human thumb. That is, the concave nature of the concave portion is substantially complementary in shape to a person's thumb at least in one direction.

The concave portion (including concave surface 112) of the first end 104 has a concave portion length D from about one (1) inch to about two (2) inches, including about 1.75 inches. Again, the length D of the concave portion may vary due to custom fitting the grooming tool 100 to a particular the hand of a user.

The second end 106 of the grooming tool 100 includes a tapered portion of a distance X, extending from a point along the central body 200 to a tip 114 at the second end 104 of the grooming tool 100. In some embodiments, the tapered portion is about one (1) inch to about two (2) inches in length, D. That is, the top surface 108 includes a second end 106 portion that is angled toward the bottom surface 110 and the bottom surface 100 includes a second end 106 portion that is angled toward the top surface 108 wherein each angled portion meet at the tip 114 of the tool 100.

The second end of the tool provides an end feature that is different from the concave surface 112 of the first end 104. The second end 106 having the taper portion also allows for targeted hair removal. The tapered second end 106 thus is easier to use in certain locations of the animal due to angles of the body of an animal as well as approach. Around sensitive areas of the animal, there is generally a desire to grab less hair or be more precise. The tapered second end 106 allows for such precision.

With reference to FIG. 1, each of the first end 104, including the concave portion having a concave surface 112 and second end 106 including the tapered portion are coated with a textured/grip enhancing coating 120. The texture coating 120 facilitates the capture of hair between the ends of the grooming tool 100 and the thumb of the user for efficiently stripping the hair off the animal. In some embodiments, the coating 120 is a 60-90 grit coating of material of a desired hardness to minimize wear and firmly adhere to the grooming tool 100. The coating 120 may be dip coated, spray coated, or applied by any means known in the art. In some embodiments, the formulation is a mechanically bonded abrasive for greater longevity. In other embodiments, a polymeric based adhesive coating is applied having abrasive grit embedded therein.

In some embodiments, the texture coating 120 is a silicon carbide coating that is thermomechanically bonded to the metal surface, e.g., by brazing. In these embodiments, the texture coating 120 is strongly bonded to grooming tool 100, and under goes minimal wear during the life of the grooming tool. In other embodiments, the texture coating 120 includes silicon carbide particles in a polymer epoxy. The entire surfaces of the tapered portion of the second end and concave portion of the first end are covered in the epoxy containing particles and cured. Being a coating, the grit of the grit enhancing coating is on the surface. Due to the strong bonding between the grit and the body of the tool 100 the grit of the texture coating 120 only needs to be present on the surface as compared to prior art tools wherein the majority of the thickness of the tool includes girt particles (wherein new particles are exposed when surface particles are worn). It is to be appreciated that the texture coating 120 on the grooming tool 100 is selectively applied, that is the texture coating 120 is present on some portions of the surface but not on other portions of the surface (such as the central body 102). This provides a tactile interface 111 such that a user, by feel alone, can determine where the texture coating 120 of the first end 104 and second end 106 begins.

The grooming tool 100 may be made of a metal material including but not limited to stainless steel, steel, aluminum, and other like metals and alloys. In some embodiments, the second end 106 having the tapered portion and the first end 104 having the concave portion are created by grinding down bars of material to the desired shapes. In other embodiments, the grooming tool 100 is made by casting.

With reference to FIG. 1, illustrated is three grooming tools of various sizes that may be manufactured according to size dimensions of a hand of a person or by user preference. For example, from left to right the grooming tool 100, 100′, 100″ has larger width dimensions. The grooming tools are still elongated with respect to its width and each of the concave/curved portion and pointed/tapered portion are covered with a grit material coating 120 as discussed above.

FIG. 2 illustrates a side perspective view of the grooming tool 100. The dimensions of the illustrated tool are not limiting. The illustration is merely used to show a tapered pointed end 106 and a concave/curved end 104. As illustrated, the concave surface 112 of the first end 104 also has a taper. That is, the first end 104 has a thickness that is greatest near the central part of the body 102 of the tool 100, and decreases in thickness towards the tip 118 of the first end 104. This allows for targeting areas of the animal for pulling hair/fur of the animal.

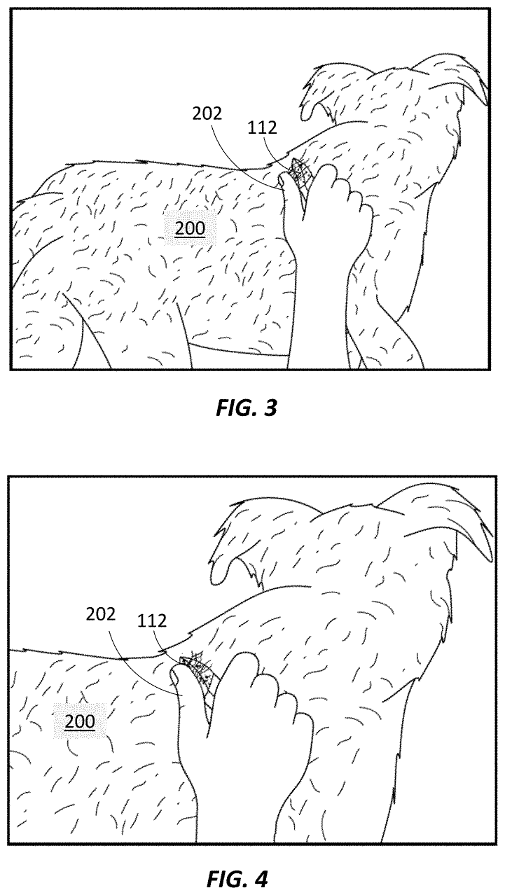

FIGS. 3-5 illustrate uses of the exemplary grooming tools, e.g., grooming tool 100, of FIGS. 1 and 2 used on a canine and a method for grooming an animal. In FIG. 3, the first end 104 having a concave surface 112 of a grooming tool 100 is placed against the animal 200 near a targeted region for hair removal. The thumb 202 of the user is away from the concave surface 112. As illustrated in FIG. 4, the thumb 202 of the user presses against the concave surface 112, capturing hair of the animal there between. That is, hair of the animal is between the thumb 202 and concave surface 112 of the grooming tool 100. When hair is pressed against the concave surface 112, the user, while keeping pressure on the concave surface 112, may move the grooming tool 100 away from the animal to put the captured hair from the animal.

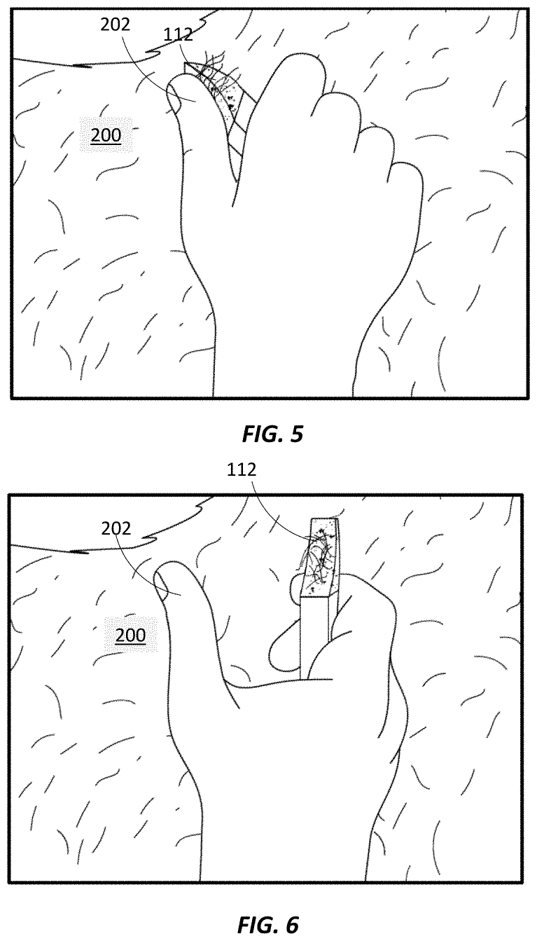

FIG. 5 is a close up view of hair on the animal captured between the girt enhanced surface of the first end 104 (concave surface 112) of the grooming tool 100 and user thumb 202. The user then pulls the grooming tool 100 away from the animal while maintaining continuous pressure on the hair captured between the thumb 202 and concave surface 112 of the grooming tool. The user, as illustrated in FIG. 6, removes the thumb 202 from contact with the concave surface 112 of the grooming tool 100, allowing the captured hair to be removed from the grooming tool 100 (i.e., dropped to the floor or otherwise disposed of). While not illustrated, the user may also use the second end 106 and the tapered portion thereof to remove hair from an animal in a similar manner.

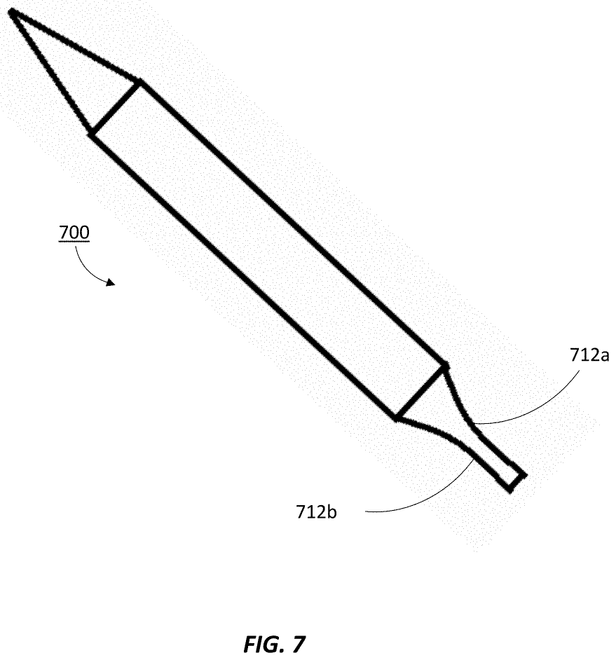

FIG. 7 illustrates another exemplary grooming tool 700 in accordance with the present disclosure. In some embodiments and as illustrated in FIG. 7, the first end 704 may have more than one concave surface 712a and 712b. That is, the grooming tool 700 may have a first concave portion 712a on the top surface and a second concave portion 712b on the bottom surface. In some embodiments, the first concave portion 712a and second concave portion 712b have the same curvature. In other embodiments, the first concave portion 712a and second concave portion 712b have different curvatures.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. An animal grooming tool comprising:
an elongated handle,
a thumb receiving portion located about a first end of the elongated handle, the thumb receiving portion having a concave curvature in at least one direction,
a texture coating on the thumb portion.

2. The animal grooming tool according to claim 1, further comprising a second end having a taper portion.

3. The animal grooming tool according to claim 2, wherein the taper portion is coated with a texture coating.

4. The animal grooming tool according to claim 1, wherein the elongated handle tapers along the concave portion.

5. The animal grooming tool according to claim 4, wherein the taper of the concave portion terminates at a point.

6. The animal grooming tool according to claim 1, wherein the grooming tool comprises a metal.

7. The animal groom tool according to claim 1 wherein the grooming tool comprises one of aluminum and steel.

8. The animal grooming tool according to claim 1, wherein the concave curvature of the thumb portion is curved in two directions.

9. The animal grooming tool according to claim 1, wherein the body includes a top surface and a bottom surface, wherein the bottom surface and top surface are angled along a portion of the second end to form a point, and wherein the top surface of the thumb portion includes a concave surface.

10. The animal grooming tool according to claim 9, wherein the thumb portion includes a second concave surface along the bottom surface of the body.

11. The animal grooming tool according to claim 1, wherein the texture coating is silicon carbide thermomechanical bonded to an entire surface area of the thumb portion.

12. The animal grooming tool according to claim 1, wherein the texture coating is a polymer based epoxy including silicon carbide particles.

13. The animal grooming tool according to claim 1, wherein the texture coating has a grit of about 60-90.

14. The animal grooming tool according to claim 1, wherein the body has a substantially rectangular cross-section.

15. The animal grooming tool, wherein a length of a tool is about three to about eight inches.

16. A method of striping the coat of an animal comprising:
providing a grooming tool having an elongated handle and a thumb receiving portion located about a first end of the elongated handle, the thumb receiving portion having a concave curvature in at least one direction;
positioning the first end of the handle proximate the body of an animal;
capturing a plurality of hairs of the animal by pressing a portion of a user's hand against the thumb receiving portion of the grooming tool; and
while maintaining pressure against the thumb receiving portion, pulling the grooming tool away from the body on the animal, removing hair.
